(19) United States
(12) Patent Application Publication
(10) Pub. No.: US 2012/0218121 A1
(43) Pub. Date: Aug. 30, 2012

(54) HUMIDITY TELEMETRY IN PROCESSING OF MATERIALS

(76) Inventor: Bela Jancsik, Philadelphia, PA (US)

(21) Appl. No.: 13/404,773

(22) Filed: Feb. 24, 2012

Related U.S. Application Data
(60) Provisional application No. 61/446,289, filed on Feb. 24, 2011.

(51) Int. Cl. G08C 15/06

(52) U.S. Cl. 340/870.02

(57) ABSTRACT

A method of monitoring the humidity of material being subjected to processing step using it humidity monitoring transducer, and transmitting humidity data from the monitoring transducer by wireless telemetry to a receiver external to the mass of material. If the material is a mass of material, the transducer can be embedded within the material. The method is particularly useful in the case of a material in a closed environment, such as packaging or if the material is in motion during the processing step, for example, when the mass of material is subjected to multiple pharmaceutical processing steps and/or plural dosage forms. The processing step can be, for example, pre-formulation, mixing, granulation, a coating step, in which a coating material is sprayed onto pharmaceutical dosage forms while the dosage forms are being tumbled.

### FIELD OF THE INVENTION

This invention relates generally to processing of chemical products, and more particularly to a novel method for monitoring the humidity of a material being subjected to a processing step. The invention has particular utility in processing of pharmaceutical medical device and food products, where monitoring of humidity during pre-formulation, granulating, coating, drying, packaging, stability, sterilization, etc., can be a critical factor in maintaining consistent high product quality.

### BACKGROUND OF THE INVENTION

Moisture or water vapor is omnipresent. It can have adverse effect on the identity, strength, quality, purity, or potency of a product as they may relate to the safety and effectiveness of the product. Furthermore, environmental conditions can catalyze moisture related degradations. Regulatory agencies, such as the FDA require validating the suitability of the processes, including the relevant container closure system relative to drug products to ensure their safety and efficacy. In addition to the harmful consequence of the water vapor, active water content of the product can further complicate the quality output of the processes, including the consequential drug delivery, stability, and evaluation of the packaging requirement.

In case of packaging, humidity measurements are conducted using probes, which are inserted through the container/closure system. This methodology damages the integrity of the package and meaningful data cannot be obtained. Another methodology is the use of data-loggers. Instead of probes, suitable size data-loggers having compatible housing, such as PyroButton-TH, are programmed for appropriate data-acquisition rate and placed into the package, which are removed after the required time. The stored data are down-loaded into the computer software and analyzed. The disadvantages of this methodology are 2 kinds; (1) Real-time moisture changes cannot be observed; (2) Once the data-logger is removed from the container/closure system the package integrity has changed, therefore returning of the data-loggers into the container/closure system disrupts the study and further evaluation and continued monitoring does not produce meaningful results.

In case of pharmaceutical processes, such as aqueous coating of pharmaceutical dosage forms of tablets or pellets, the control of the humidity of the product bed is very important. Over-wetting can harm the products' efficacy, affects the plasticizer therefore drug delivery, whereas under-wetting can result in poor quality of the coating due, for example, to inadequate film formation, or require substantially longer coating times, which can drastically increase the utilization of energy. The humidity in these processes is not controlled directly. Recently, suitable types of data-loggers, such as PyroButton-TH have been used for the measurement of humidity. The data-loggers are programmed at the required data-acquisition rate and placed in the coating pan at fixed positions and the tablet bed. At the end of the process the data-loggers are withdrawn and the data, are down-loaded into the computer. The disadvantage of this methodology is due to the fact, that real-time humidity data cannot observed and any out-of-specification process condition cannot corrected in time.

### SUMMARY OF THE INVENTION

In one of its broader aspects, the invention is a method of monitoring the humidity of material being subjected to processing step. The method comprises including, along with the material, a humidity monitoring transducer, and transmitting humidity data from the monitoring transducer by wireless telemetry to a receiver external to the mass of material. Where the material is a mass of material, the transducer can be embedded within the material. The method is particularly useful in the case of a material being in a closed environment, such as packaging or if the material is in motion during the processing step, for example, when the mass of material comprises multiple pharmaceutical process steps and dosage forms. The processing step can be, for example, pre-formulation, mixing, granulation, a coating step, in which a coating material is sprayed onto pharmaceutical dosage forms while the dosage forms are being tumbled.

In another of its broader aspects, plural humidity monitoring transducers can be embedded into individual packaging for studies of reproducibility or within a mass of material, and humidity data can be transmitted from the humidity monitoring transducers over independent wireless channels to a receiver external to the mass of material, so that the humidity of each transducer can be ascertained independently, in accordance with another aspect of the invention the humidity of pharmaceutical dosage forms in a bed comprising multiple dosage forms in a random array being subjected to a processing step, is monitored by including a humidity monitoring transducer within the bed, and transmitting humidity data from the monitoring transducer by wireless telemetry to a receiver external to the bed. Preferably, the pharmaceutical dosage forms and the transducer are moved during the processing step, and the transducer is of a size, shape and weight such that its movement within the bed is substantially indistinguishable, from the movement of the pharmaceutical dosage forms in the bed.

Because the humidity measurement technique in accordance with the invention improves humidity control, and can be used to prevent over-wetting or under-wetting, or improper wetting rate, or unsuitable transient time of moisture exposure, it is particularly suitable for use in measurement of the humidity of moisture sensitive biological materials, which can be degraded over time by hydrolysis or in the case of temperature processes, such as coating of biologics, which are typically denatured at around 37° C., and humidity must controlled to prevent moisture induced degradation.

Where the processing includes deposition of a drop of liquid on each tablet of an array of tablets and passing the array of tablets through a drying stage, the humidity monitoring transducer can be included in the array along with the tablets.

In some cases, the drying of the tablets prior to the coating process is required to a specific moisture end-point. Currently, this is being done in a rotating coating pan of the coating equipment at a given rpm, temperature and air flow of a given tablet quantity. At a given time, sample of the tablets are withdrawn from the coating pan for moisture analysis. After the moisture analysis, the tablets will not be returned to the coasting pan due to GMP compliance or due to the fact that in most eases the analytical method is destructive to the samples. The process is repeated several times until the required moisture state has been reached. This method is time consuming, costly, and is known to have poor reproducibility. A more efficient and cost effective method is by monitoring the humidity within the coating pan in real time utilizing the humidity transducers, which can be placed randomly within the moving tablets to measure the moisture of evaporation in real-time. The number of humidity transducers, which can do the measurement in parallel and display the data in real-time utilizing appropriate software, which meets 21 CFR Part 11 compliance, can be as many as 25.

### BRIEF DESCRIPTION OF THE DRAWINGS

FIG. 1 is an image of the tablet shaped humidity sensor placed into a container prior to capping.

FIG. 2 is a schematic and graph showing the placement of the humidity sensors at various positions in the coating equipment, including at fixed points inside the equipment and within the tablet to obtain process real-time “map” of the process. Above the schematic the real-time measurement data are presented

FIG. 3 is the out-of-specification control table for the coating process control based on the humidity measurement data.

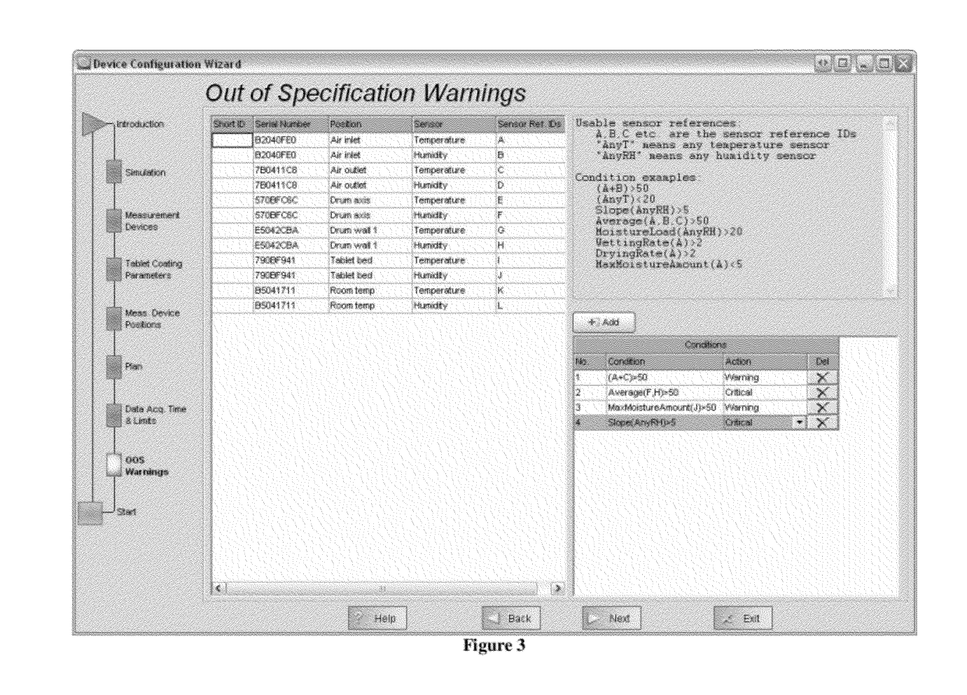

### DETAILED DESCRIPTION OF THE PREFERRED EMBODIMENT

In the following description, the terms “transducer” and “sensor tablet” are both used to refer to a wireless humidity transducer having a size, shape and weight, comparable to the size, shape and weight of a pharmaceutical tablet. However, unless otherwise qualified, the term “transducer” should be understood as encompassing wireless transmitting humidity transducers having various shapes, weights, sizes and characteristics other than those of a pharmaceutical tablet.

One advantage of the use of wireless transmission is that each sensor can be set to transmit at a different frequency thereby permitting use of a plurality of different sensors to monitor a single processing step since the data from each sensor can be distinguished based on the frequency at which it is transmitted. This also allows for location of the sensors in the processing step which may be important, for example, in monitoring of large production processes such as batch processes. For example, two, three or more receivers can be positioned at different locations to receive the transmissions from the sensors and then the positions of the sensors at a given moment can be determined by, for example, triangulation or any other suitable method. In addition, due to the nature and/or size of the sensors used in the present method, processing steps can be monitored by video cameras to provide information about the location of sensors at a particular point in time.

The humidity sensor virtual tablet contains a power source in the nature of a chemical cell (commonly referred to as a “battery”) that provides DC power to the electronic circuitry, including the humidity sensor. The signal is transmitted from the tablet and through the receiver transferred via a USB interface and 21 CFR Part 11 compliant software to the computer. A plurality of humidity sensors can be placed in the equipment such as tablet coating equipment, fluid bed processors, other suitable processing equipment or suitable packages. The signal is continuously monitored by the 21 CFR Part 11 compliant software and evaluated by proprietary algorithms in real-time control to verify the compliance to the process specifications, as applicable. Appropriate alarms can be set for timely intervention into the process to ensure that specifications are maintained.

The use of miniature humidity transmitting tablet affords a substantial improvement over other currently used method of humidity monitoring in coating, fluid bed and packaging applications. The sensor tablet makes it possible to measure the humidity of the product in the coating pan, fluid bed processor and packaging directly and to a very high degree of accuracy as the process takes place. The antenna and receiver are of small in size, and can be transferred easily from one type of equipment to another, or a single antenna/receiver combination can monitor multiple processes and packages.

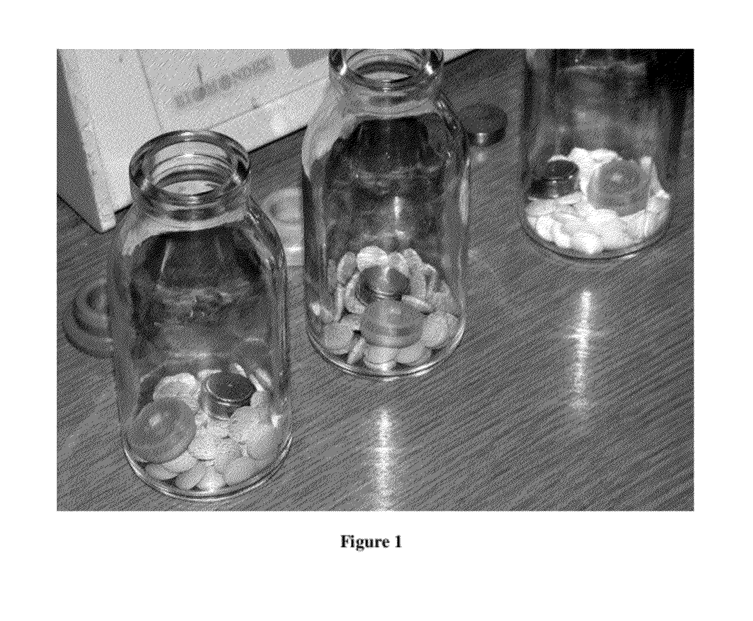

As shown in FIG. 1, multiple packages can be monitored at the same time. For validation purposes both data-loggers and the humidity transducer device are place in the container along with the product. Multiple packages can be set up under varied environmental conditions to obtain real-time on packaging suitability and validation. For example one can determine in real-time where the moisture coming from? Is the packaging allows penetration of the moisture from the outside environment or the moisture is released from the product due to the free water. Additionally, the efficacy and the efficiency for the optimum type of desiccant can be determined in a compliant manner.

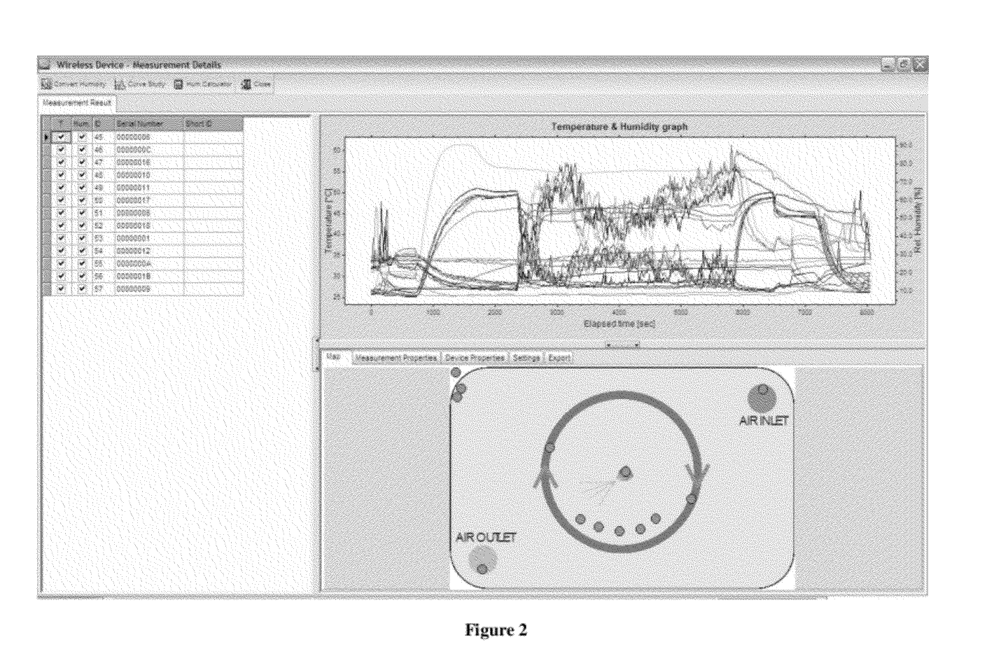

FIG. 2 illustrates a coating apparatus map and the positioning of the humidity sensors with the graphical representation of the real-time data. The fixed positioning of the tablet sensors at the inlet of the, where controlled temperature hot air is blown at a given CFM onto the rotating tablets, at the outlet, where the exhaust extracts the hot & moist air from the internal coating environment, at the spray gun, which measures the head space in the coating pan at that point, and fixed to the perforations of the rotating drum to measure the circulating head space. The fixed positioned humidity transducers transmit data at a given data-acquisition rate, which has been synchronized to the rotation of the coating pan. The transmitted data provides multi-dimensional information about the humidity environment of the coating space. Furthermore, the scheme represents a set of humidity tablet sensors, which are placed into the tablet bed along with the “real” tablets, which are referred to as virtual tablets. These virtual tablets rotate with the “real” tablets and collect humidity data. Humidity sensor based data-loggers of different weight, but tablet size and shape are also included for comparison and verification to determine the effect of weight variations within a given interval relative to the mixing characteristics and the validity of the signal representation to the humidity effect on the “real” tablets.

The coating material can be any of a variety of known coating materials. In the case of pharmaceutical tablets, for example, a typical coating material is a combination of a polymer such as polyvinyl alcohol (PVA), polyvinylpyrrolidone (PVP) or hydroxypropylmethylcellulose (HPMC), in combination of plasticizers, surface active agents, pigments, and an opacifier using water as the solvent. The water partially evaporates as the spray approaches the bed of tablets and continues to evaporate while in contact with the tablets, leaving a solid coating. The effect of the humidity dynamics relative to the rate of wetting, moisture transient time on the tablets' surface, drying affect the plasticizer characteristics, therefore the glass transition temperature, therefore drug delivery. The above described moisture dynamics also affects the stability of the drug product. The polymer surface of the humidity transducer is coated in an analogous manner to the “real” tablets. The deposited solid material represents the deposit on the “real” tablets. The movements of the humidity sensors are random, which allows meaningful interpretation of the signals.

The sensor tablets, or transducers, transmit sensed humidity data from sensor tablets at slightly different frequencies along with a unique identifier. The sensors been used in the range of over 10 m with sufficient signal strength. The life expectancy of the battery depends on the data-acquisition rate. In a typical application they can be used continuously for 168 hours. After use they can be cleaned with water or in case of EC coating with Sodium Bicarbonate solution.

Experiments were carried out using a PyroTab-TH/RF and PyroButton-TH utilizing appropriate programming and reading accessories, of Opulus, 1420 Locust St., Suite 18N, Philadelphia, Pa. USA. Both devices can be calibrated utilizing the PSC-TH calibrator and PyroSys-360 software from Opulus of the same address. ProCept, O'Hara 19 inch, Vector 24 inch, Thomas 36 inch, and Manesty 60 inch coating pans were used in the experiments. The sensor set-up maps are indicated in FIG. 2.

In the initial tests, 25 unused and calibrated PyroTab-TH/RF sensors were placed into each batch of tablets to be coated, as indicated by the map. Later, the sensors were washed and reused to test their longevity.

The PyroTab-TH/RF sensors were allowed to be coated along with the tablets. Data from ten different coating runs were collected using the PyroButton-TH and 14 different runs were collected using PyroTab-TH/RF and PyroTab-TH sensors for comparison. Data trend were similar in signal pattern and intensity relative to the given coating parameters.

As seen in FIG. 2, the humidity of the tablet sensors have shown variations relative to the spray cycles, whereas the fixed positioned sensors have shown steady state measurements. Meaningful interpretation of the data have been performed using various mathematical tools for curve smoothing and cycle term evaluations for humidity load, rate of wetting, rate of drying, and moisture dispersion. The humidity acquisition times can be adjusted to correlate with the drum rotational speed.

Humidity profiles derived from experiments have shown that the variations in the humidity can be detected relative to the type of formulation of the coating suspensions and parameter settings of the tablet coating equipment (see, FIG. 2).

The results of the tests of the PyroTab-TH/RF and PyroButton-TH for monitoring coating operations show that the humidity profile observed in both cases resemble each other.

In addition, larger batch sizes exhibited different coating patterns, which can be used for scale up development. Thus, the use of humidity sensing tablets is likely to prove especially beneficial in the case of scale up optimization.

Although the process of the invention has been described in the context of tablet coating by a batch process using a rotating coating pan, the advantages of the process can be realized in tilted drum coaters, and also in the context of continuous coaters, i.e., devices utilizing rotating drums through which a supply of tablets moves continuously. Likewise, the process of the invention can be used with other forms of coating apparatus, such as a continuous or batch-type coater in which a bed of tablets is fluidized and tumbled by a flow of air or by vibratory motion. In a continuous coating process, humidity sensing tablets can be introduced periodically into a moving mass of tablets, and recovered at the outlet of the coater.

The utility of the invention is also not limited to coating of pharmaceutical tablets, or even to coating. For example the process of the invention has potential utility in coaters used in the manufacture of candy and food products. Furthermore the process of the invention may be used wherever, a process is being carried out in which the monitoring of humidity of a mass of material is required, and it impossible, inconvenient or impractical to insert a fixed probe into the mass of material.

The humidity measurement technique of the invention can also be used to advantage in the manufacture of continuous coating processes. In this case the pharmaceutical tablets are moved along conveyor type system while continuously being sprayed and dried at the same time to ensure the necessary and sufficient coating quality relative to drug delivery, quality, and aesthetics. Humidity may be currently monitored using fixed sensors; however, in process dynamics relative to humidity cannot be monitored. Moreover, the tracking of product moisture history, Which is made possible by the use of wireless sensors, can be particularly important in the processing of moisture-labile compounds that are subjected to the higher humidity required during the wetting phase. The humidity measurement technique of the invention can also be used in fluid bed drying and other operations in which moisture is supplied to a material, e.g., high shear wet granulation, crystallization, precipitation, and fermentation. The humidity measurement technique of the invention can also be used in applications in which water is removed from a material, e.g. lyophilization or “freeze-drying.” The humidity measurement technique of the invention can also be used to monitor humidity in packaging or package contents during sterilization procedures such as ethylene oxide sterilization.

Many conventional drug substances destined for therapeutic use are unstable in aqueous solution, and must therefore be converted into solid products. Lyophilization is commonly used to achieve the desired product stability. However, lyophilization takes place in a series of stages: initial freezing, in which an aqueous solution of the drug is frozen; primary drying, in which a vacuum is applied and ice is sublimed; and secondary drying, in which residual moisture is removed by diffusion, desorption, and/or evaporation. It is important to monitor the humidity in each of these stages. However, lyophilization is frequently carried out while the product is in a sealed vial so that it is difficult or impossible to make a direct humidity measurement using a conventional probe. Moreover, the wires leading from a conventional wired probe can be a source of contamination. The incorporation of one or more wireless humidity sensors into the product throughout the lyophilization process makes it possible to achieve continuous, accurate, and direct humidity measurement while avoiding the difficulties associated with wired probes.

What is claimed is:

1. A method of monitoring the humidity of a material being subjected to processing step, the method comprising: including, along with said material, a humidity monitoring transducer; and transmitting humidity data from said monitoring transducer by wireless telemetry to a receiver external to said material during said processing step.

2. The method according to claim 1, in which said material is a mass of material, and in which the humidity monitoring transducer is embedded within said mass of material.

3. The method according to claim 2, in which the mass of material is a flowable mass that is in motion during said processing step.

4. The method according to claim 2, in which the mass of material is composed of multiple pharmaceutical dosage forms.

5. The method according to claim 4, in which the processing step is a coating step.

6. The method according to claim 5, in which the processing step is a coating step in which a coating material is sprayed onto the pharmaceutical dosage forms while the pharmaceutical dosage forms are being tumbled.

7. The method according to claim 2, in which plural humidity monitoring transducers are embedded within said mass of material, and humidity data are transmitted from said humidity monitoring transducers, by wireless telemetry, to a receiver external to said mass of material.

8. The method according to claim 2, in which plural humidity monitoring transducers are embedded within said mass of material, and humidity data are transmitted from said humidity monitoring transducers over independent wireless channels to a receiver external to said mass of material, whereby the humidity measured by each transducer can be ascertained independently.

9. The method according to claim 1, in which the processing step includes moisture monitoring within a closed packaging system.

10. The method according to claim 1, in said material is a mass of material being subjected to lyophilization, and wherein the humidity monitoring transducer is embedded within said mass of material during lyophilization.

11. A method of monitoring the humidity of pharmaceutical dosage forms in a bed comprising multiple dosage forms in a random array while subjected to a processing step, the method comprising: including a humidity monitoring transducer within said bed; and transmitting humidity data from said monitoring transducer by wireless telemetry to a receiver external to said bed during said processing step.

12. The method of claim 11, in which the processing step is a coating step.

13. The method according to claim 11, in which the processing step is a coating step in which a coating material is sprayed onto the pharmaceutical dosage forms and the transducer while the pharmaceutical dosage forms are being tumbled.

14. The method according to claim 11, in which the pharmaceutical dosage forms and said transducer are moved during the processing step. and in which the transducer is of a size, shape and weight such that its movement within said bed is substantially indistinguishable from the movement of the pharmaceutical dosage forms in said bed.

15. The method according to claim 11, in which plural humidity monitoring transducers are included within said bed, and humidity data are transmitted from said humidity monitoring transducers, by wireless telemetry, to a receiver external to said bed.

16. The method according to claim 11, in which plural humidity monitoring transducers are included within said bed, and humidity data are transmitted over independent wireless channels from said humidity monitoring transducers to a receiver external to said bed, whereby the humidity measured by each transducer can be ascertained independently.

17. The method according to claim 1, wherein said material is a medical device being subjected to ethylene oxide sterilization, and in which the humidity monitoring transducer is located within the sterilizer.

18. The method according to claim 1, in said material is a medical device packaging being subjected to ethylene oxide sterilization, and in which the humidity monitoring transducer is embedded within the packaging during the sterilization process.
